(19) United States
(12) Patent Application Publication
(10) Pub. No.: US 2024/0253441 A1
(43) Pub. Date: Aug. 1, 2024

(54) ELECTRIC DRIVE UNIT WITH REMOVABLE THROUGH SHAFT

(71) Applicant: Dana Heavy Vehicle Systems Group, LLC, Maumee, OH (US)

(72) Inventors: Gustav JOHNSON, Canton, MI (US); Jordan M. HOUSER, Sylvania, OH (US); Darren J. ZISKOVSKY, Bowling Green, OH (US)

(21) Appl. No.: 18/161,782

(22) Filed: Jan. 30, 2023

(51) Int. Cl. B60K 1/00

(52) U.S. Cl. CPC B60K 1/00; B60K 2001/001

(57) ABSTRACT

A system for an electric drive unit. The electric drive unit includes, in one example, a first shaft with a through shaft opening and a second shaft axially aligned with the first shaft. The electric drive unit further includes a through shaft that axially extends through the through shaft opening and removably attaches to the first shaft and the second shaft.

### TECHNICAL FIELD

The present disclosure relates to an electric drive unit with a removable through shaft that when removed prevents a traction motor from receiving rotational input.

### BACKGROUND AND SUMMARY

Electric powertrains include motors that generate motive power for electric vehicles (EVs). These electric powertrains provide an attractive alternative in terms of hydrocarbon emissions in relation to vehicles that solely rely on internal combustion engines to generate motive power. Certain electric powertrains include transmissions that allow the power output of the motor to be transferred to drive wheels.

It may be desirable to prevent electric motors from rotating during certain operating conditions, such as when the EV is being towed. Specifically, when the electric motor spins during towing operation, the motor generates electromagnetic fields (EMFs) while electrical power supplied to the motor is inhibited. The EMFs have the potential to degrade some motor components.

To prevent EMF generation, the EV may be placed on a flatbed trailer during towing. However, this type of towing may be costly and impractical for certain types of vehicles that have comparatively large heights and/or weights, for example.

U.S. Pat. No. 11,433,765 B2 to Perry et al. teaches an electric axle architecture with an axle disconnect device that allows powertrain rotation and specifically traction motor rotation to be stopped to avoid EMF generation. Perry's axle disconnect device mounts to one output of a differential.

The inventors have recognized several potential issues with the axle disconnect device disclosed in U.S. Pat. No. 11,433,765 B2. For instance, Perry's disconnect device is electronically actuated via a controller which allows the powertrain to be quickly disconnected via electronic control signal. However, if the controller or battery is not operational, the axle disconnect device may be correspondingly non-operational. As such, under certain conditions, the axle disconnect device may not function when needed. Further, when the axle disconnect device is activated, the differential will continue to spin during towing, thereby increasing differential wear and the likelihood of differential degradation.

The inventors have recognized the abovementioned issues and developed an electric drive unit to at least partially overcome the issues. The electric drive unit, in one example, includes a first shaft with a through shaft opening and a second shaft that is axially aligned with the first shaft. The electric drive unit further includes a through shaft that axially extends through the through shaft opening and removably attaches to the first shaft and the second shaft. Designing an electric drive unit with a removable through shaft that exhibits these features enables the through shaft to be reliably and manually removed prior to towing or other operating conditions where it is desirable to avoid rotation of a traction motor in the electric drive unit. Further, the through shaft is able to be removed regardless of the state of a controller, battery, and the like that may be included in the electric drive system, if desired.

Further, in one example, to achieve the removable attachment between the through shaft and the first and second shafts, the through shaft may be splined to the first and second shafts. In this way, a strong and detachable connection is formed between the through shaft, the first shaft, and the second shaft.

Further, in one example, the first shaft may be a rotor shaft in a traction motor and the second shaft may be an input shaft of a gearbox and where the input shaft has a gear fixedly coupled thereto. It this way, the through shaft is efficiently incorporated into the traction motor and may be more easily accessed.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a schematic diagram of an electric drive unit.

FIG. 2A is an illustration of an electric drive unit with a traction motor that has a removable through shaft.

FIG. 2B is an illustration of the electric drive unit, depicted in FIG. 2A, with the through shaft decoupled from the traction motor.

FIG. 3 is an illustration of a splined interface between shafts in an electric drive unit.

### DETAILED DESCRIPTION

An electric drive unit with a removable through shaft, that when removed inhibits a traction motor from receiving rotational input, when desired, is described herein. Using the through shaft to inhibit motor rotation allows a vehicle operator or other personnel to reliably and effectively disable the motor during selected conditions such as vehicle towing. The through shaft may be removably connected to a rotor shaft and an input shaft, in one example. However, in other examples, the through shaft may be removably coupled to another pair of shafts in the electric drive unit. Splines and/or a shaft flange may be used to achieve the removable attachment between the through shaft and the rotor and input shafts. In this way, a strong connection between the through shaft and the input and rotor shafts is formed that can be effectively disconnected, when desired, such as prior to towing operation to avoid electromagnetic field (EMF) generation and component degradation.

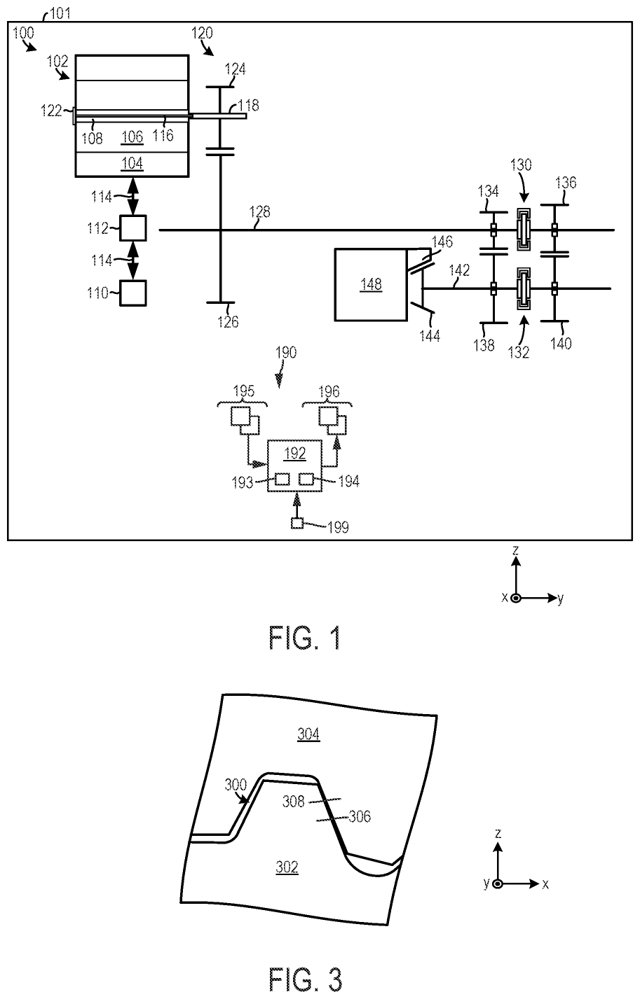

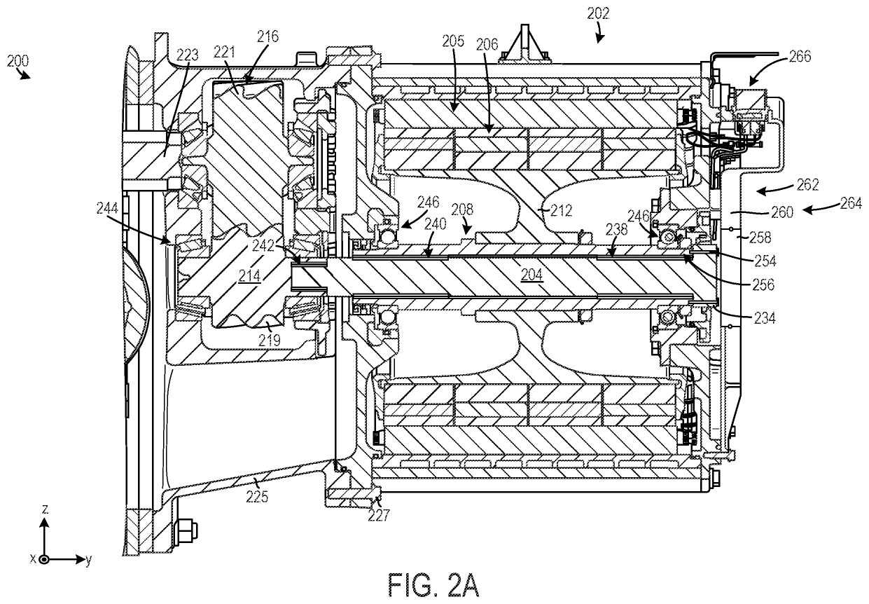

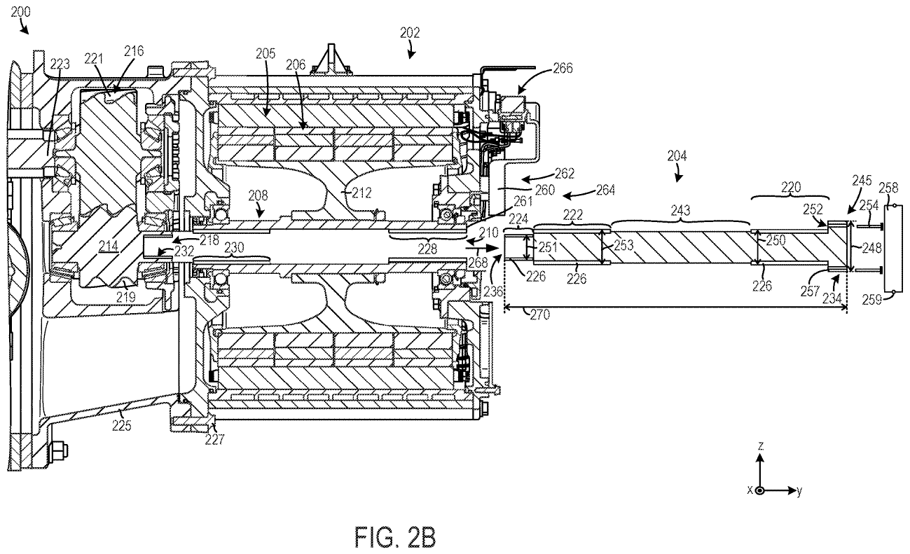

FIG. 1 shows a schematic depiction of an electric drive unit with a removable through shaft that enables rotational input to a traction motor to be effectively inhibited. FIGS. 2A and 2B show detailed views of an example of an electric drive unit with a through shaft mated with a rotor shaft and an input shaft, in FIG. 2A, and decoupled from the rotor shaft and the input shaft in FIG. 2B. FIG. 3 shows a detailed view of a splined interface between shafts in an electric drive unit.

FIG. 1 depicts an example of an electric drive unit 100 (e.g., an electric axle) that may be included in an electric vehicle (EV) 101. The electric drive unit 100 may specifically be an electric axle, in one example, which can be more easily incorporated into a variety of vehicle platforms when compared to other types of electric drives. To elaborate, the electric axle may be an electric beam axle that is coupled to a dependent suspension system to increase axle durability and articulation when compared to axles that are coupled to independent suspension systems. However, the axle may be coupled to an independent suspension system, in other examples.

The EV 101 may be an all-electric vehicle in one example, although alternative examples are possible such as a hybrid electric vehicle (HEV) that utilizes an internal combustion engine for propulsion and/or recharging of an energy storage device. Further, the EV 101 may be a light, medium, or heavy duty vehicle, for instance. To elaborate, the vehicle may be a commercial vehicle (e.g., a vehicle that has a gross weight which is greater than or equal to 4,536 kilograms (kg)).

The electric drive unit 100 includes a traction motor 102 with a stator 104 which electromagnetically interacts with a rotor 106 to generate motive power during motor operation. The rotor 106 includes a rotor shaft 108. Further in one example, the traction motor 102 may be a motor-generator which is designed to generate electrical energy during regeneration operation.

The traction motor 102 may be electrically coupled to one or more energy storage device(s) 110 (e.g., one or more traction batteries, capacitor(s), fuel cell(s), combinations thereof, and the like) by way of an inverter 112 when the machine is designed as alternating current (AC) machine. However, a direct current (DC) electric machine may be used in alternate examples.

Arrows 114 denote the electrical connection between the traction motor 102, the inverter 112, and the energy storage device(s) 110. The inverter 112 may be designed to convert DC to AC and vice versa. In one use-case example, the traction motor 102 and the inverter 112 may be three-phase devices which can achieve greater efficiency when compared to other types of motors. However, motors and inverters designed to operate using more than three phases have been envisioned.

A through shaft 116 is removably coupled to the rotor shaft 108 and an input shaft 118 of a gearbox 120, in the illustrated example. However, it will be appreciated that the through shaft 116 may be removably coupled to another pair of shafts in the gearbox 120. For instance, the through shaft may be removably coupled to a pair of adjacent shafts that are downstream of the input shaft. To enable the removable coupling between the through shaft 116, the rotor shaft 108, and the input shaft 118, splines, flanges, and/or fasteners may be used. A detailed example of a through shaft is expanded upon herein with regard to FIGS. 2A-2B. A removable cover 122 may further be included in the traction motor 102. The removable cover 122 may allow the through shaft to be accessed and reduce the likelihood of contamination of interior motor components.

The input shaft 118 may include a gear 124 fixedly coupled thereto. The gear 124 may mesh with a gear 126 that is fixedly coupled to a shaft 128. The gearbox 120 is illustrated as a multi-speed gearbox 120 with clutches 130 and 132 that are designed to shift between different gear combinations in the gearbox. However, multi-speed gearboxes with a different number of clutches (e.g., a single clutch or more than two clutches) or a single speed gearbox may be used in the electric drive unit 100, in other embodiments.

The clutch 130 is designed to selectively engage a gear 134 and a gear 136 that are idly mounted to the shaft 128. Likewise, the clutch 132 is designed to selectively engage a gear 138 and a gear 140 that are idly mounted to a shaft 142 (e.g., output shaft). The gear 138 meshes with the gear 134 and the gear 140 meshes with the gear 136 in the illustrated example. However, numerous gear layouts are possible in the gearbox.

The shaft 142 may include a gear 144 that meshes with a gear 146 in a differential 148. The differential 148 may be rotationally coupled to drive wheels via axle shafts (e.g., half shafts).

The electric drive unit 100 may further include a control system 190 with a controller 192 as shown in FIG. 1. The controller 192 may include a microcomputer with components such as a processor 193 (e.g., a microprocessor unit), input/output ports, an electronic storage medium 194 for executable programs and calibration values (e.g., a read-only memory chip, random access memory, keep alive memory, a data bus, and the like). The storage medium may be programmed with computer readable data representing instructions executable by a processor for performing methods and control techniques.

The controller 192 may receive various signals from sensors 195 coupled to various regions of the EV 101 and the gearbox 120. For example, the sensors 195 may include a pedal position sensor designed to detect a depression of an operator-actuated pedal such as an accelerator pedal and/or a brake pedal, a speed sensor at the gearbox output shaft, energy storage device state of charge (SOC) sensor, clutch position sensors, and the like. Motor speed may be ascertained from the amount of power sent from the inverter to the electric machine. An input device 199 (e.g., accelerator pedal, brake pedal, drive mode selector, combinations thereof, and the like) may further provide input signals indicative of an operator's intent for vehicle control.

Upon receiving the signals from the various sensors 195 of FIG. 1, the controller 192 processes the received signals, and employs various actuators 196 of vehicle and/or electric drive unit components to adjust the components based on the received signals and instructions stored on the memory of controller 192. For example, the controller 192 may receive an accelerator pedal signal indicative of an operator's request for increased vehicle acceleration. In response, the controller 192 may command operation of the inverter 112 to adjust electric machine mechanical power output and increase the power delivered from the traction motor 102 to the gearbox 120. The controller 192 may during certain operating conditions, be designed to send commands to the clutches 130 and 132, to engage and disengage the clutches. For instance, a control command may be sent to one of the clutches and in response to receiving the command, an actuator in the clutch may adjust the clutch based on the command for clutch engagement or disengagement. The other controllable components in the vehicle may function in a similar manner with regard to sensor signals, control commands, and actuator adjustment, for example.

An axis system is provided in FIG. 1 as well as FIGS. 2A, 2B, and 3, for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

It will be appreciated that the electric drive unit 100 shown in FIG. 1 discloses one or many possible architectures. For instance, the electric drive unit may include a single speed gearbox with a different number of shafts and gears, in one example, or the number of operating gears in the gearbox may be increased, in another example.

FIGS. 2A and 2B show an example of an electric drive unit 200 (e.g., electric axle) with a traction motor 202 with a through shaft 204 installed in the traction motor and removed from the traction motor respectively. The electric drive unit 200 may include at least some structural and/or functional features that are similar to the electric drive unit 100, shown in FIG. 1. Redundant description of the overlapping components is omitted for brevity.

The traction motor 202 includes a stator 205 and a rotor 206 with a rotor shaft 208. The rotor shaft 208 includes through shaft opening 210. Further, the rotor shaft 208 may be coupled to a spider 212 which may be coupled to laminations, for instance.

The electric drive unit 200 further includes an input shaft 214 of a gearbox 216. The input shaft 214 includes a through shaft recess 218. The through shaft recess 218 may only partially extend through the input shaft 214. However, in other examples, the through shaft recess may extend axially from one end of the shaft to the other end. In alternate examples, the through shaft may include an input shaft recess that mates with an axial extension of the input shaft. In other words, a portion of the through shaft may circumferentially surround and mate with a portion of the input shaft.

The through shaft 204 is removably coupled to the rotor shaft 208 and the input shaft 214 via mating with the through shaft opening 210 and the through shaft recess 218. In this way, the through shaft 204 is able to be manually and reliably removed from the rotor shaft 208 and the input shaft 214 or vice versa.

The gearbox 216 may include a gear 219 coupled to or otherwise integrally formed on the input shaft 214. The gear 219 may mesh with a gear 221 that is fixedly coupled to a shaft 223. The shaft 223 may be rotationally coupled to downstream components such as gears, clutches, and/or a differential, for instance.

A housing 262 of the traction motor 202 may be coupled to a housing 225 of the gearbox 216 via attachment devices 227. The housing 225 may at least partially enclose the gears 219, 221.

In the illustrated example, the through shaft 204 includes a first section of splines 220, a second section of splines 222, and a third section of splines 224. Each of the sections of splines include multiple splines 226. The first and second section of splines 220, 222 mate with a first section of splines 228 and a second section of splines 230, respectively, in the rotor shaft 208. Further, the third section of splines 224 mates with a third section of splines 232 in the input shaft 214, in the illustrated example. The mating between the splines form splined interfaces 238, 240, and 242. Further, the through shaft 204 includes an un-splined section 243 between the first and second section of splines 220, 222, in the illustrated example.

However, alternate spline configurations in the through shaft are possible. For instance, the through shaft 204 may include one set of splines that extend from a flange 234 on a proximal end 245 to a distal end 236 of the shaft. Further, in an alternate example, the through shaft may include one set of splines that mates with splines in the input shaft and one set of splines that mates with splines in the rotor shaft. Even further in other examples, the through shaft may include more than three sets of splines.

The abovementioned splines may be involute splines, in one example, to increase the strength of the shaft connection when compared to straight splines. However, in other examples, straight splines may be used.

Bearings 244 (e.g., thrust bearings) are directly coupled to the input shaft 214 in the illustrated example. Further, bearings 246 (e.g., ball bearings) are directly coupled to the rotor shaft 208 in the illustrated example. To elaborate, the bearings 244, 246 are coupled to opposing ends of the respective shafts. The bearings allow for shaft support and rotation. As described herein, a bearing may include inner and outer races as well as roller elements (e.g., balls, cylinders, tapered cylinders, and the like). The first section of splines 220 axially extends across the section of the rotor shaft 208 that is coupled to one of the bearings 246. Likewise, the second section of splines 222 axially extends across the section of the rotor shaft 208 that is coupled to one of the bearings 246. However, in alternate examples, the sections of splines may be axially offset from the bearings 246.

The through shaft 204 includes the flange 234 in the illustrated example. The flange 234 has a diameter 248 that is greater than a diameter 250 of the first section of splines 220 of the through shaft 204. Further, a diameter 251 of the third section of splines 224 may be less than the diameter 250 of the first section of splines 220. Further, a diameter 253 of the second section of splines 222 may be equal to the diameter 250 of the first section of splines 220. Designing the through shaft with these contours allows the through shaft to be efficiently installed and removed from the rotor shaft 208 and the input shaft 214. However, in other examples, the through shaft 204 may include one section of splines that extends from the flange 234 to the distal end 236 and in such an example, the diameter of the splined section may be constant, along its axial length.

Further, an axial length 270 of the through shaft 204 may be greater than an axial length of the rotor shaft 208 to allow the through shaft to removably attach to both the rotor shaft and the input shaft. However, in other examples, the input shaft may include an extension that mates with a recess in the through shaft and the length of the through shaft may be less than or equal to a length of the rotor shaft.

Further, the flange 234 includes openings 252 through which attachment devices 254 (e.g., bolts) extend. The attachment devices 254 are further profiled to attach to a section 256 of the rotor shaft 208. Further, a surface 257 of the flange 234 may abut a surface 261 of the rotor shaft 208, when the through shaft is installed in the motor. In this way, the rotor shaft may axially delimit the through shaft. The flange 234 allows the strength of the attachment between the through shaft 204 and the rotor shaft 208 to be increased and may reduce an amount of axial play between the rotor shaft 208 and the through shaft 204 as well as reduce the likelihood of unintended decoupling of the through shaft from the rotor shaft and the input shaft. However, in other examples, the flange 234 may be removed from the shaft.

The traction motor 202 further includes a removable cover 258 that removably attaches to a section 260 of the housing 262. The section 260 of the housing 262 is on an axial side 264 of the motor that includes an electrical interface 266. The electrical interface 266 serves as an electrical connection between end windings in the stator 205 and an inverter and/or energy storage device. A seal 259 may be included in the removable cover 258 to form a seal between the cover and the traction motor housing, to reduce the likelihood of the interior of the motor becoming contaminated. To elaborate, the seal may circumferential surround the cover.

To remove the through shaft 204, as shown in FIG. 2B, the cover 258 may be initially removed. Subsequently, the attachment devices 254 may be decoupled from the input shaft 214 and the flange 234. Next, the through shaft 204 is axially slid in direction 268 until the splines in the through shaft 204 are decoupled from the splines in both the input shaft 214 and the rotor shaft 208. The steps of cover removal, attachment device removal, and through shaft removal may be sequentially implemented by a vehicle operator or other personnel while the traction motor 202 is shutdown. The steps may be reversed to re-install the through shaft and allow the electric drive unit to be again operated to transfer mechanical power from the traction motor to the drive wheels. In this way, the through shaft may be effectively and reliably removed and reinstalled from the rotor shaft and the input shaft.

FIG. 3 shows a detailed illustration of a splined interface 300 between a through shaft 302 and a shaft 304 (e.g., a rotor shaft or an input shaft of a gearbox). Splines 306 in the through shaft 302 are shown mating with splines 308 in the shaft 304. The splines 306, 308 are depicted as involute splines. However, straight splines may be used in alternate examples, as previously discussed.

FIGS. 2A and 2B are drawn approximately to scale, aside from the schematically depicted components, although other relative component dimensions may be used in other embodiments.

FIGS. 1, 2A, 2B, and 3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The invention will be described in the following paragraphs. In one aspect, an electric drive unit is provided that comprises a first shaft with a through shaft opening; a second shaft axially aligned with the first shaft; and a through shaft that axially extends through the through shaft opening and removably attaches to the first shaft and the second shaft.

In another aspect, an electric axle is provided that comprises a traction motor with a rotor shaft that includes a through shaft opening; a gearbox with an input shaft that has a gear coupled thereto; and a through shaft that axially extends through the through shaft opening and removably attaches to the rotor shaft and the input shaft.

In another aspect, a traction motor is provided that comprises a stator; a rotor at least partially circumferentially surrounded by the stator and including a rotor shaft with a through shaft opening; and a removable through shaft splined to the through shaft opening and including a distal section that is configured to spline to a splined recess in an input shaft of a gearbox.

In any of the aspects or combinations of the aspects, the first shaft may be a rotor shaft in a traction motor and the second shaft may be an input shaft of a gearbox and wherein the input shaft has a gear fixedly coupled thereto.

In any of the aspects or combinations of the aspects, the gearbox may be a multi-speed gearbox wherein the traction motor is a multi-phase motor.

In any of the aspects or combinations of the aspects, the through shaft may be splined to the first shaft and the second shaft.

In any of the aspects or combinations of the aspects, the splines in the through shaft may include: a first set of splines with a larger diameter that mate with the first shaft; and a second set of splines with a smaller diameter that mate with the second shaft.

In any of the aspects or combinations of the aspects, the splines may be involute splines.

In any of the aspects or combinations of the aspects, the through shaft may include a flange at a first end that is opposite to a second end that removably attaches to the second shaft;

and the flange may removably attach to the first shaft.

In any of the aspects or combinations of the aspects, the electric drive unit may further comprise a cover that extends across the first end of the through shaft and removably attaches to a section of a housing of a traction motor.

In any of the aspects or combinations of the aspects, the section of the housing may include an electrical interface electrically coupled to a stator.

In any of the aspects or combinations of the aspects, the electric drive unit may be included in an all-electric vehicle.

In any of the aspects or combinations of the aspects, the all-electric vehicle may be a commercial vehicle.

In any of the aspects or combinations of the aspects, the through shaft may include: a first splined section that mates with splines in the through shaft opening; and a second splined section that mates with splines in the input shaft.

In any of the aspects or combinations of the aspects, the second splined section may have a smaller diameter than the first splined section.

In any of the aspects or combinations of the aspects, the splines in the through shaft opening may be positioned on opposing axial sides of the through shaft opening.

In any of the aspects or combinations of the aspects, the through shaft may include a flange at a first end that is opposite a second end that extends into the input shaft; and a plurality of attachment devices may extend through the flange and are removably coupled to a section of the rotor shaft.

In any of the aspects or combinations of the aspects, the through shaft may include a flange at a proximal end and the traction motor may further comprise a removable cover that encloses the proximal end of the through shaft.

In any of the aspects or combinations of the aspects, the removable cover may include a gasket sealing with a section of a housing.

In any of the aspects or combinations of the aspects, the splines may have varying diameters.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of electric machines and/or internal combustion engines. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range, unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric drive unit comprising:
a first shaft with a through shaft opening;
a second shaft axially aligned with the first shaft; and
a through shaft that axially extends through the through shaft opening and removably attaches to the first shaft and the second shaft.

2. The electric drive unit of claim 1, wherein the first shaft is a rotor shaft in a traction motor and the second shaft is an input shaft of a gearbox and wherein the input shaft has a gear fixedly coupled thereto.

3. The electric drive unit of claim 2, wherein the gearbox is a multi-speed gearbox wherein the traction motor is a multi-phase motor.

4. The electric drive unit of claim 1, wherein the through shaft is splined to the first shaft and the second shaft.

5. The electric drive unit of claim 4, wherein the splines in the through shaft include:
a first set of splines with a larger diameter that mate with the first shaft; and
a second set of splines with a smaller diameter that mate with the second shaft.

6. The electric drive unit of claim 4, wherein the splines are involute splines.

7. The electric drive unit of claim 1, wherein:
the through shaft includes a flange at a first end that is opposite to a second end that removably attaches to the second shaft; and
the flange removably attaches to the first shaft.

8. The electric drive unit of claim 7, further comprising a cover that extends across the first end of the through shaft and removably attaches to a section of a housing of a traction motor.

9. The electric drive unit of claim 8, wherein the section of the housing includes an electrical interface electrically coupled to a stator.

10. The electric drive unit of claim 1, wherein the electric drive unit is included in an all-electric vehicle.

11. The electric drive unit of claim 10, wherein the all-electric vehicle is a commercial vehicle.

12. An electric axle comprising:
a traction motor with a rotor shaft that includes a through shaft opening;
a gearbox with an input shaft that has a gear coupled thereto; and
a through shaft that axially extends through the through shaft opening and removably attaches to the rotor shaft and the input shaft.

13. The electric axle of claim 12, wherein the through shaft includes:
a first splined section that mates with splines in the through shaft opening; and
a second splined section that mates with splines in the input shaft.

14. The electric axle of claim 13, wherein the second splined section has a smaller diameter than the first splined section.

15. The electric axle of claim 13, wherein the splines in the through shaft opening are positioned on opposing axial sides of the through shaft opening.

16. The electric axle of claim 12, wherein:
the through shaft includes a flange at a first end that is opposite a second end that extends into the input shaft; and
a plurality of attachment devices extend through the flange and are removably coupled to a section of the rotor shaft.

17. A traction motor comprising:
a stator;
a rotor at least partially circumferentially surrounded by the stator and including a rotor shaft with a through shaft opening; and
a removable through shaft splined to the through shaft opening and including a distal section that is configured to spline to a splined recess in an input shaft of a gearbox.

18. The traction motor of claim 17, wherein the through shaft includes a flange at a proximal end and the traction motor further comprises a removable cover that encloses the proximal end of the through shaft.

19. The traction motor of claim 18, wherein the removable cover includes a gasket sealing with a section of a housing.

20. The traction motor of claim 17, wherein the splines have varying diameters.
